(19) United States
(12) Patent Application Publication
(10) Pub. No.: US 2007/0252307 A1
(43) Pub. Date: Nov. 1, 2007

(54) THERMOFORMED CONTAINER WITH INWARDLY EXTENDING CUT LIP

(76) Inventor: Rodney D. Borst, Oregon, WI (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/764,481

(22) Filed: Jun. 18, 2007

Related U.S. Application Data
(63) Continuation-in-part of application No. 10/051,566, filed on Jan. 18, 2002, now Pat. No. 7,232,541.
Application No. 10/051,566 is a continuation of application No. PCT/US01/40619, filed on Apr. 27, 2001.

(51) Int. Cl. B29C 51/00

(52) U.S. Cl. 264/316; 220/260

(57) ABSTRACT

A thermoformed container has an outwardly projecting ridge and an inwardly facing cut lip. A technique for manufacturing the container includes positioning a heated sheet of thermoplastic material over a three-part mold. The mold defines a cavity corresponding to the shape of the container and includes separable first, second, and third portions. The first and second portions define an undercut portion corresponding to a ridge on the container. The heated sheet of thermoplastic material is forced into the cavity. The sheet of thermoplastic material is cut along an upper lip of the first portion to form the container. The first portion is separated from the container by moving either the first portion or the second and third portions away from each other. The second portion is moved away from the container and the third portion. The container is removed from the third portion.

### CROSS-REFERENCE TO RELATED APPLICATIONS

This application is a continuation-in-part of U.S. patent application Ser. No. 10/051,566 filed Jan. 18, 2002, which is a continuation of International Application No. PCT/US01/40619 filed Apr. 27, 2001, which are hereby incorporated by reference.

### BACKGROUND OF THE INVENTION

The present invention relates to thermoformed containers and more specifically, but not exclusively, concerns a unique technique of manufacturing the thermoformed containers. The unique technique for manufacturing the containers includes a three-part mold which imparts an inwardly extending cut lip and an outwardly extending ridge in the thermoformed container.

Thermoforming is a process of heating a thermoplastic sheet to working temperature and then forming it to a finished shape by means of heat or pressure. In a typical thermoforming system set up for continuous forming, the sheet is heated in an oven then moved to a forming press. There the softened plastic material is forced against the mold surface by vacuum or air pressure until it sets. During the forming process, a sheet clamp may hold the sheet flat at the edges of the mold. A single mold may be used or matched male and female molds may be used to assist the forming process.

When the material has set, it may be moved to a trim press where a steel rule or matched punch and die cut the part from the sheet. The use of separate dies can cause some misregistration between the molded part and the cutting die, and accordingly a cut in-place configuration may be used where the sheet is formed and trimmed in the same station.

Thermoforming can produce extremely thin-walled parts with low tooling costs. Nevertheless, there are a number of limitations to the thermoforming process. First, the cut lip of the flange may give the products an unfinished look. To the extent that the cut lip reveals the thinness of the material, packaging using thermoforming techniques may look inexpensive.

Even with cut in-place systems, it is difficult to control the dimension and alignment of the cut lip, limiting the application of thermoforming in products where a tight tolerance must be held on this outer dimension.

The light weight and low cost of thermoformed products make it critical that the products be nested for economical shipping. Nevertheless, the implicit symmetry to a thermoformed sheet causes nested products to stack tightly, making de-nesting a problem.

The cut lip of the thermoformed product interferes with attempts to create a closed container with tight sealing.

### BRIEF SUMMARY OF THE INVENTION

One aspect concerns a method of thermoforming a container. The method includes positioning a heated sheet of thermoplastic material over a three-part mold. The three-part mold defines a cavity corresponding to the shape of the container. The mold includes separable first, second, and third portions. The first portion includes an upper lip and an upper part of an undercut portion. The second portion includes a lower part of the undercut portion and a surface corresponding to sidewalls of the container. The undercut portion forms a ridge in the container. The third portion includes a surface corresponding to a base of the container. The method includes forcing the heated sheet of thermoplastic material into the cavity and cooling the heated sheet of thermoplastic material below its corresponding glass transition temperature. The method also includes cutting the cooled sheet of thermoplastic material along the upper lip of the mold to form the container and separating the first portion from the container positioned in the second and third portions of the mold by moving either the first portion or the second and third portions away from each other. Additionally, the method includes moving the second portion away from the container and the third portion until the second portion is clear of the container and removing the container from the third portion of the mold.

Yet another aspect concerns a closable thermoformed container. The container includes an upper container made of a thermoplastic material. The thermoplastic material is positioned in a three-part mold configured to define a cavity corresponding to the shape of the upper container. The upper container has a top portion connected to an upper ridge, wherein the upper ridge includes a plurality of inwardly-projecting portions alternating with a plurality of sidewall portions. The inwardly-projecting portions and the sidewall portions extend to a cut lip to define the volume of the upper container. The container also includes a lower container made of a thermoplastic material. The thermoplastic material is positioned in a three-part mold configured to define a cavity corresponding to the shape of the lower container. The lower container has a base connected with a continuous lower sidewall and a lower ridge, wherein the lower ridge includes a plurality of inwardly-projecting portions alternating with a plurality of sidewall portions. The inwardly-projecting portions and the sidewall portions extend to a cut lip to define a volume of the lower container. When the upper and lower containers are locked together, the inwardly-projecting portions of the upper container and the lower container nest together and the sidewall portions of the upper container and the lower container align.

Another aspect concerns a method of thermoforming a container. The method includes positioning a heated sheet of thermoplastic material over a three-part mold defining a cavity corresponding to the shape of the container. The mold includes separable first, second, and third portions. The method includes pressing the heated sheet of thermoplastic material into the cavity and cutting the sheet of thermoplastic material along a lip of the first portion to form the container. The method also includes moving the container, the second portion, and the third portion downwardly away from the first portion. Additionally, the method includes contacting the third portion with an ejector plug to stop movement of the third portion while the second portion continues moving downwardly until clear of the container. The container is removed from the third portion.

Further forms, objects, features, aspects, benefits, advantages, and embodiments will become apparent from a detailed description and drawings provided herewith.

### BRIEF DESCRIPTION OF THE DRAWINGS

FIG. 1 is a perspective view of a thermoformed container produced according to the present invention, having an inwardly extending cut lip.

FIG. 2 is a cross-sectional view of the container of FIG. 1 taken along line 2-2 of FIG. 1 showing the inwardly extending cut lip and an outwardly extending ridge positioned beneath the cut lip.

FIG. 3 is a fragmentary cross-sectional view of a thermoforming machine for producing the container of FIGS. 1 and 2, showing the drawing of a sheet of thermoplastic material into a cavity having an undercut portion.

FIG. 4 is a second view of the machine of FIG. 3 showing a die cutting of the cut lip of the container of FIGS. 1 and 2 as produced in the thermoforming machine, with a retraction of portions of the cavity to release the part therefrom.

FIG. 5 is a fragmentary cross-section of the container of FIG. 2 when nested with other similar containers showing the action of the ridge and cut lip in holding the containers with their bases in separation.

FIG. 6 is a fragmentary view of FIG. 5 showing the effect of the shape of the ridge in providing a gap between containers suitable for a de-nesting pawl or the like.

FIG. 7 is a cross-sectional fragmentary view of the upper edge of a container produced by the present invention attached to a second container also according to the present invention to connect together at interengaging ridges into a single unit.

FIG. 8 is a figure similar to that of FIG. 7 showing the use of a hemicircular rather than rectangular interengaging ridges.

FIG. 9 is a figure similar to that of FIGS. 7 and 8 showing the use of interengaging ridges with two different shapes to provide dual lines of sealing between the first and second containers.

FIG. 10 is a figure similar to FIGS. 7 through 9 where the second container has a vertically rather than inwardly extending flange to assist in separating the containers.

FIG. 11 is a figure similar to FIGS. 7 through 10 having a recessed terrace for receiving the inwardly extending cut lip of the second container so as to provide a seamless outer profile that is tamper resistant.

FIG. 12 is a figure similar to FIGS. 7 through 11 showing placement of a flexible release tab between the two containers that may be pulled upward to release the containers from one another.

FIG. 13 is a figure similar to FIGS. 7 through 12 showing the use of a rotatable cam element for separating the interengaging ridges of the two containers.

FIG. 14 is a figure similar to FIGS. 7 through 12 showing the position of a cut-out near the ridge of the second container and an embossment near the ridge of the first container, extending through the cut-out when the containers are assembled together, permitting opposed finger pressure to release the containers from one another.

FIG. 15 is a figure similar to FIGS. 7 through 13 showing a three-part container having an insert for supporting a product against an upper clear container base.

FIG. 16 is a front elevational view of an example container using the present techniques.

FIG. 17 is a cross-section through the container of FIG. 16 along line 17-17 showing the interfitting of two halves and an internal plastic liner.

FIG. 18 is a front perspective view of a cubical container such as may be produced by the present technique.

FIG. 19 is a cross-sectional view through the container of FIG. 18 along lines 19-19 showing the interfitting of the container halves.

FIG. 20 is a front perspective view of a three-part container employing the techniques of the present invention.

FIG. 21 is a cross-sectional view of the container of FIG. 20 along lines 21-21 showing the three elements of the container.

FIG. 22 is a front perspective view of an example container using the present techniques.

FIG. 23 is a cross-sectional view through the container of FIG. 22 along lines 23-23 showing the interfitting of the container halves.

FIG. 24 is a front perspective view of an example container using the present techniques.

FIG. 25 is a cross-sectional view through the container of FIG. 22 along lines 23-23 showing the interfitting of the container halves.

FIGS. 26-37 are front views of manufacturing an example container using the present disclosed techniques according to one embodiment.

FIG. 38 depicts front perspective views of example containers and corresponding cross-sectional views of the example containers using the present disclosed techniques.

FIG. 39 depicts front perspective views of example containers and corresponding cross-sectional views of the example containers using the present disclosed techniques.

FIG. 40 is a front perspective view of an example container and a corresponding cross-sectional view of the example container using the present disclosed techniques.

FIG. 41 depicts front perspective views of example containers and corresponding cross-sectional views of the example containers using the present disclosed techniques.

FIG. 42 depicts front perspective views of example containers and corresponding cross-sectional views of the example containers using the present disclosed techniques.

FIG. 43 depicts front perspective views of example containers and corresponding cross-sectional views of the example containers using the present disclosed techniques.

FIG. 44 is a side view of another embodiment of a thermoformed container, including an upper portion and a lower portion, produced according to the present invention.

FIG. 45 is a bottom view of the FIG. 44 container in an open position.

FIG. 46 is a bottom view of the FIG. 44 container in a closed position.

FIG. 47 is a cross-sectional view of the container of FIG. 45 taken along line 47-47 of FIG. 45 container.

FIG. 48 is a cross-sectional view of the container of FIG. 46 taken along line 48-48 of FIG. 46 container.

FIG. 49 is a top view of a lower container.

FIG. 50 is a side view of another embodiment of a thermoformed container, including an upper portion and a lower portion, produced according to the present invention.

FIG. 51 is a side view of another embodiment of a thermoformed container, including an upper portion and a lower portion, produced according to the present invention.

### DETAILED DESCRIPTION OF THE PREFERRED EMBODIMENT

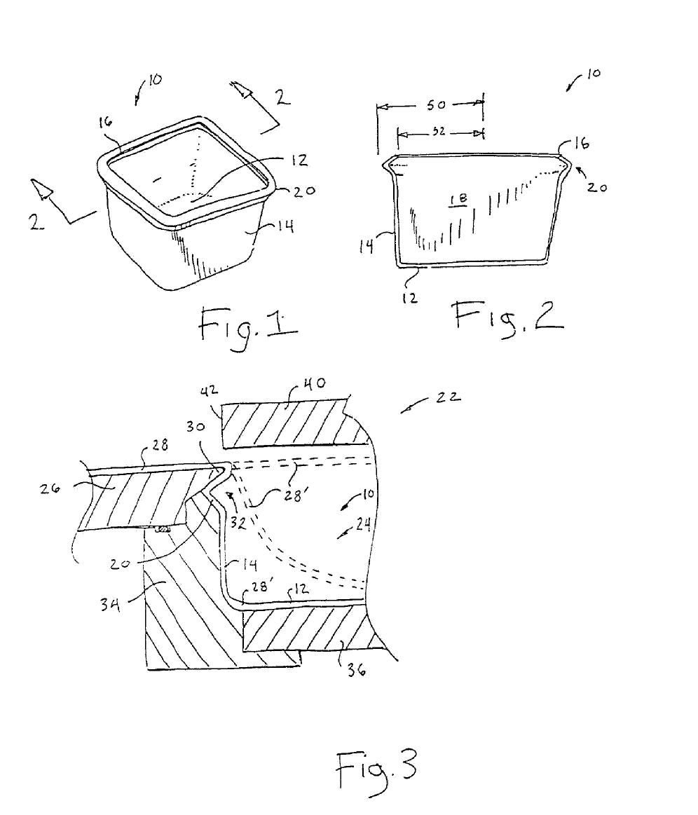

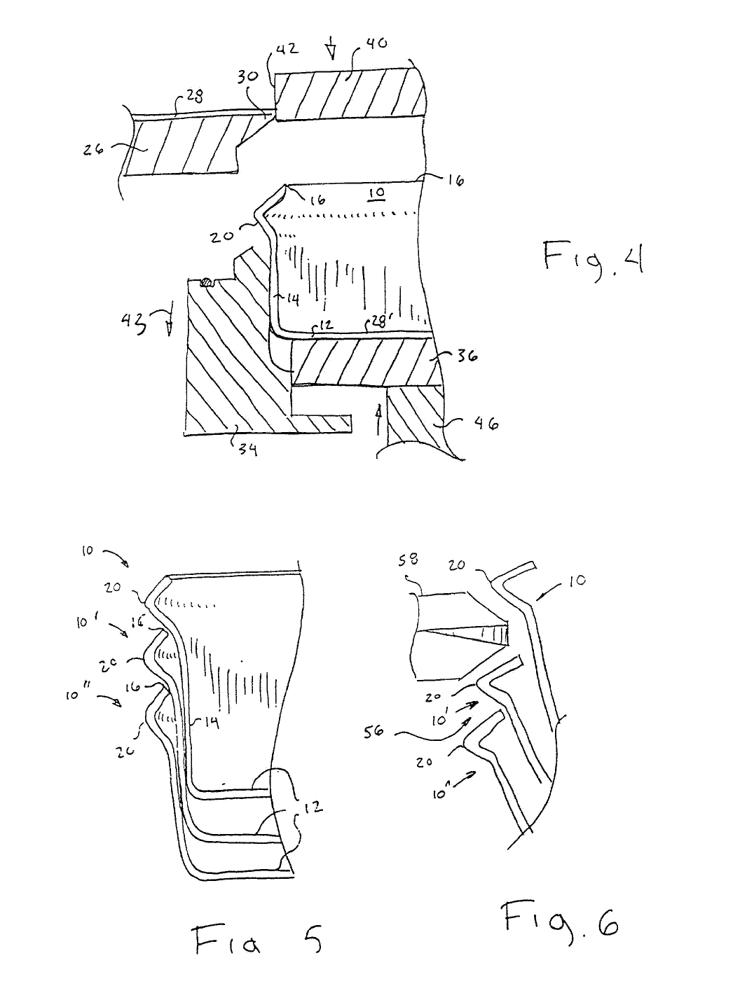

Referring now to FIGS. 1 and 2, a thermoformed container 10 includes a generally planar base 12 attached at its periphery to upstanding side walls 14 which terminate at an upper cut lip 16. The base 12 and walls 14 enclose a volume 18 with the cut lip 16 generally extending inward about the volume 18. In a conventional thermoformed product, the cut lip 16 would extend outward away from volume 18 so as to be clear from the walls 14 for a die cutting operation. Positioned beneath the cut lip 16 is a ridge 20 extending about the circumference of the upper edge of the container 10 and protruding outward away from the volume 18.

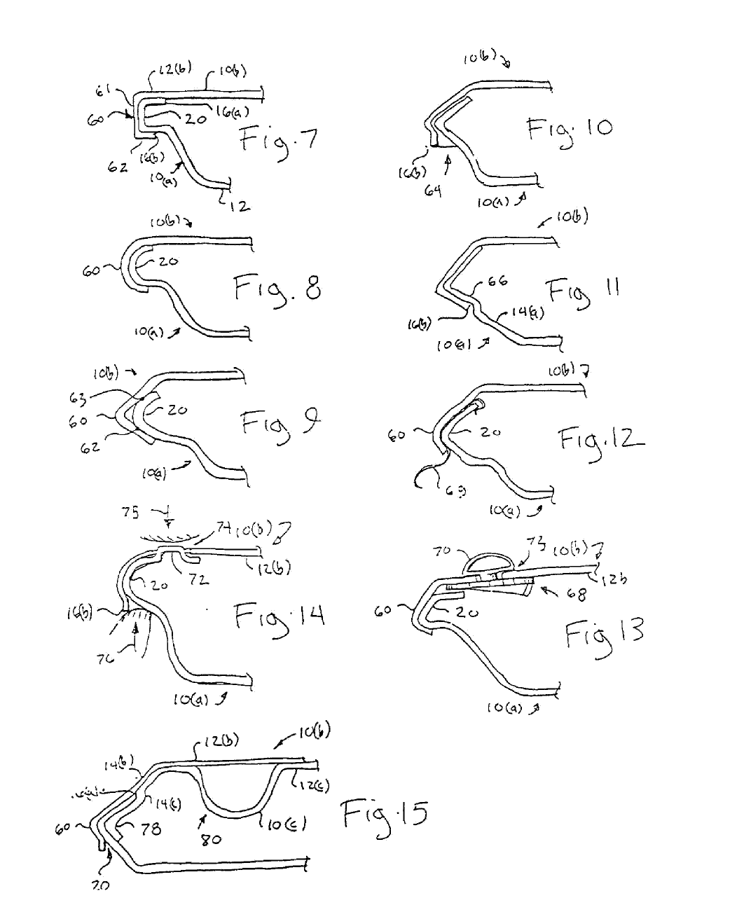

Referring now to FIG. 3, the container 10 may be formed on a thermoforming machine 22 having a cavity 24 generally conforming in shape to the outer surface of the container 10. The cavity 24 is positioned to provide a recess under a forming table 26, the latter which provides a planar upper surface across which a sheet of thermoplastic material 28 may slide.

The heated sheet 28 may be drawn down into the cavity 24 as shown by dotted outlines 28′ by means of a relative vacuum provided beneath the sheet 28′ in the cavity 24 through one or more orifices or nested by another portion of the machine (not shown).

In the drawing operation, the sheet 28′ is formed over an upper lip 30 defining the edge of the cavity 24. The cavity 24 is formed from three mold components: the lip 30 (being part of the table 26) which also provides a first-half of an undercut portion 32, a second mold portion 34, which abuts the underside of the lip 30 and provides a second half of the undercut portion and a surface shaping the side walls 14, and a third mold portion 36 which defines the shape of the base 12 and may move independently of the second mold portion 34 as will be described. The undercut portion 32 forms the ridge 20 in the finished container.

The interface between the lip 30 and the second mold portion 34 is aligned with the extreme outermost extent of the ridge 20 to permit the container 10 (to be formed in the cavity 24) to be removed from the cavity 24 by a separation of lip 30 and the second mold portion 34. During the forming process, a die 40 is positioned above the cavity 24 with a vertical cutting edge 42 aligned with the lip 30.

Referring now to FIG. 4, after the sheet 28 has been drawn down to conform with the inner surfaces of the cavity 24, including being drawn into the undercut portion 32, it is allowed to cool below its glass transition temperatured thus ensuring that it will retain its shape once pressure has been released. At this time, the mold portion 34 and 36 move downward together as indicated by arrow 43 while die 40 cuts through sheet 28 at lip 30 releasing the container 10 from sheet 28.

Once the sheet 28 has been cut through by the shearing action between lip 30 and cutting edge 42, die 40 stops moving whereas mold portions 34 and 36 continue moving downward until the cut lip 16 is clear from the structure of the lip 30. At this time, mold portion 34 continues downward motion, but mold portion 36 is stopped by ejector peg 46 pushing upward on mold portion 36 with respect to mold portion 34 ejecting the container 10 from the mold cavity 24. The container 10 may then be moved laterally into a collection bin (not shown).

Die 40 then moves upward and sheet 28 again moves out over the cavity 24 which is reassembled by the upward motion of mold portions 34 and 36. The splitting of the portions 34 and 30 at the outermost extent of the ridge 20 allows removal of the container 10 from the cavity 24 without interference with the mold components.

Referring again to FIG. 2, the dimension 50 from the center of the container 10 to its outermost extent, representative of an outside dimension of the container 10, will be accurately controlled by the dimensions of the cavity 24. The accuracy of dimension 52, representing the distance between the center of the container 10 and the cut lip 16, need not control of the closeness of fit between the container and the cover. Accordingly, designs that require a precise outside dimension and accurately located outside rim will be possible with the present invention. Furthermore, because the cut lip 16 is displaced from the outside dimension, the upper edge of the container 10 presents a smooth profile suitable for many containers as will be described. The cut lip 16 may not be smooth.

Referring now to FIG. 5, one aspect of the present invention is that it permits the design of containers 10 that may be readily de-nested after they have been nested together. Generally, thermoformed containers are nested for efficient shipping. Because thermoformed containers are manufactured of a single, essentially constant thickness sheet it is normally very hard to keep the nested containers from fitting into one another so tightly as to prevent their ready de-nesting. In particular, the bases 12 and side walls 14 may abut so closely as to prevent air flow between these surfaces, thus creating a vacuum when the containers are to be de-nested. Further, the cut lip 16 of the container (normally facing outward) may abut making it difficult to selectively grasp a single container for de-nesting.

As shown in FIG. 5, the present container 10 may be nested into a second identical container 10′ which may in turn be nested into yet a third identical container 10″. In this case, rather than the bases 12, 12′ and 12″ abutting, the depth of nesting of the containers is controlled by the interference between the ridges 20 and the cut lips 16 of the next lower container. By proper dimensioning of the ridges 20 and the cut lip 16, the amount of spacing between the containers 10, 10′ and 10″ may be precisely controlled to prevent to dense of nesting and to space bases 12 apart.

Further, referring to FIG. 6, the ridges 20 may be shaped so that a generous gap 56 exists between adjacent containers (for example, 10′ and 10″) to permit a de-nesting pawl 58 to easily fit between containers 10 and 10′ in the gap 56, for example, to provide compatibility with an automatic de-nesting device. Because dimensions 50 and 52 (shown in FIG. 2) and the shape of the ridges 20 are essentially independent, great flexibility in the amount of nesting may be obtained. Critical to this feature of the invention is that the ridge 20 have at least one wall obtusely angled with respect to an adjoining portion of the side wall 14 so as to be able to rest on the inwardly extending cut lip 16.

Referring now to FIG. 7, a first container 10(a) may provide a rectangular ridge 20 as viewed in cross-section, having a top and bottom radially extending wall generally parallel to the base 12 flanking a vertically extending wall generally perpendicular to the base 12. The cut lip 16 in this case is at the inner edge of the upper radially extending wall.

A second container 10(b) may be fabricated having a ridge 60 formed as a vertically extending wall 61 extending downward from a base 12(b), the base 12(b) and wall 61 abutting the upper radial wall and vertically extending wall of the ridge 20, respectively.

The lower extent of the vertical wall 61 may include an inwardly extending radial wall 62 terminating in a cut lip 16(b) and abutting the lower radial wall of the ridge 20.

A slight deformation of the thermoplastic material of the containers 10(a) and 10(b) permits this second container 10(b) to serve as a lid to container 10(a), ridge 60 snapping in place over ridge 20. The ability to precisely control the outer dimension of the ridge 20 and ridge 60 permits the interfitting of these containers 10(a) and 10(b) as shown. Note that the cut lips 16(a) and 16(b) need not be precisely located for sealing to occur between containers 10(a) and 10(b).

A cohesive or adhesive may be placed between ridge 20 and ridge 60; however, mechanical force will normally hold the containers 10(a) and 10(b) together.

Referring to FIG. 8, containers 10(a) may instead employ ridge 20 and ridge 60 that are hemicircular in cross-section to provide a smoother contour of the ridges to assist in the snapping of the containers 10(a) and 10(b) together. Further, the radius of ridge 20 may be slightly greater than that inner radius of ridge 60 so as to eliminate play in a vertical direction. Similarly, the radius of the container 10(b) analogous to dimension 50 in FIG. 2 may be somewhat less than that radius on container 10(a) to provide a tight seal, the difference in radius being accommodated by a slight unrolling of the ridge 60.

Referring to FIG. 9, conversely the ridge 20 of container 10(a) may be given a slightly smaller cross-sectional radius than the ridge 60 of container 10(b), and ridge 60 may be given an angular cross-section so as to promote contact between ridge 20 and ridge 60 at two rings of contact 63 at which a cohesive or adhesive may be placed to provide a double-sealing of the containers.

Referring to FIG. 10, the cut lip 16(b) of container 10(b) may extend vertically so as to provide a gap 64 between container 10(a) and 10(b), providing a purchase for a user's finger such as may assist in the separation of containers 10(a) and 10(b) once they are connected.

On the other hand, separation of the containers 10(a) and 10(b) may be intentionally made more difficult, for example, for the production of a tamper-proof container, by forming in the side wall 14(a) of container 10(a) a depressed terrace 66 displaced toward the center of container 10(a) by a distance substantially equal to the thickness of the sheet from which container 10(b) is formed. The terrace 66 is positioned near the cut lip 16(b) when the containers 10(a) and 10(b) are assembled, so that the terrace 66 causes the cut lip 16(b) to lie substantially flush with the side wall 14a to resist a catching of cut lip 16(b) to separate the two containers.

Referring now to FIG. 12, a flexible tab 69 such as a cloth or plastic strip, may be attached to one of the containers 10(a) and 10(b) to extend outward between the ridge 20 and ridge 60 to be grasped by a user of the containers 10(a) and 10(b) and pulled to assist in separating these containers.

Separation of the containers may also be promoted by means of a cam disk 68 having an operator 70 protruding through an aperture 73 in the base 12 (b) of container 10 (b). The operator is accessible to a user and when rotated also rotates the cam disk 68 which is positioned on the inside of the closed containers 10(a) and 10(b), with a portion extending between ridge 20 and ridge 60. As the cam disk 68 is rotated, its thickness between ridge 20 and 60 increases, separating the two containers 10(a) and 10(b) without a pulling on the containers.

Referring now to FIG. 14, the upper radial wall of ridge 20 may include an upwardly extending embossment 72 providing a button which may protrude through an aperture 74 cut in the base 12(b) of container 10(b). The embossment 72 so formed may be pressed downward as indicated by arrow 75 by finger pressure while upward force indicated by arrow 76 may be exerted against the cut lip 16(b) of container 10(b), also by finger pressure. The result is that both containers may be pushed apart with a simple one-handed action, without the need for a firm grip, for example, on the lower container 10(a) as would be required for pulling container 10(a).

Referring now to FIG. 15, a three-part container may be constructed having a lower and upper container 10(a) and 10(b), respectively, locked together by means of ridges 60 and 20. A third container 10(c) is held between them and provides a ridge 78 just fitting into the inside of ridge 20. The container 10(c) has a side wall 14(c) which continues upward from ridge 78 across the cut lip 16(a)of container 10(a) and along the side wall 14(b) of container 10(b) to have its base 12(c) run parallel to base 12(b) of container 10(b). The base 12(c) may include one or more pockets 80 to contain product for display through a transparent container 10(b). The pockets 80 may conform to the product to arrange it for attractive display through the container 10(b).

Referring now to FIGS. 16 and 17, the containers 10(a) and 10(b) need not function as base and lid, but may form two halves of a general container such as a dispensing container 82 shown in FIG. 16. Such a container may have a front and rear face comprised of containers 10(a) and 10(b). A separately formed nozzle 84, which may be injection molded, can be attached to a hole formed in the containers 10(a) and 10(b), respectively.

Here, the containers 10(a) and 10(b) provide both a product storage volume 86 and a handle 88 and permit great flexibility in surface design and package dimension. Referring to the cross-section of FIG. 17, the halves 10(a) and 10(b) are assembled using the tamper-resistant joint generally described with respect to FIG. 11, where the cut lips 16(b) of container 10(b) rest in terraces created in container 10(a).

Product 89 contained within the container 82 may be held loosely in the container 82 or may be contained in a flexible plastic bag 90 as may be preferred for very fine powdered or liquid product 89.

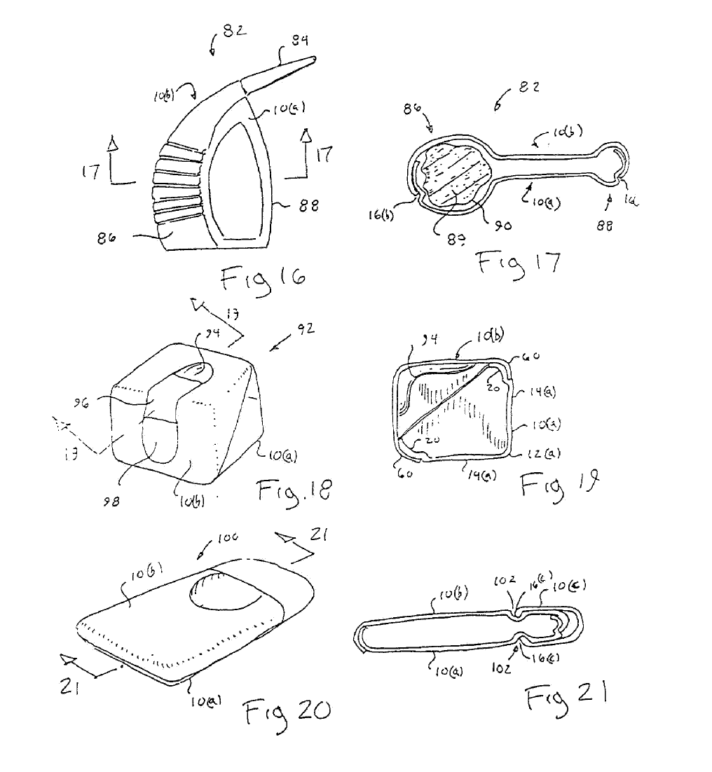

Referring now to FIGS. 18 and 19, containers 10(a) and 10(b) may together form a rectangular parallelepiped container 92 without external flanges. In this case, the division between containers 10(a) and 10(b) divides the parallelepiped along the diagonals of two opposed faces and follows edges of the other two pairs of faces.

Referring to the cross-sectional view of FIG. 19, container 10(a) has a base 12(a) that is simply the corner between two of the faces of the container 92 and the side walls 14(a) proceed upward at approximately 90.degree. angles from each other. The ridges 20 and 60 fit together with the seam of FIG. 11 to provide corners between two of the faces.

In the embodiment shown, the container 92 may be adapted for use as a dispenser with a depression 94 formed in two of the faces of container 10(b) as may be covered by an “L” cap 96 fitting around the corner of the two faces and attached by an adhesive sticker at one side to provide a hinge 98. An aperture may be cut in the depression 94 underneath the “L” hinge 98 to provide access to products stored inside the volumes contained by halves 10(a) and 10(b).

Referring now to FIGS. 20 and 21, a second three-part container may be formed where the third component provides not a product-supporting insert, but a cap holding the other 10 two components together. Specifically, shells 10(a) and 10(b) may be fit together as has been previously described. A ridge 102 providing a depression extending inward toward the volume contained by containers 10(a) and 10(b) may be formed in containers 10(a) and 10(b) so as to produce a channel running around the container 100 crossing both containers 10(a) and 10(b). A third container 10c in this case has inwardly extending cut lips 16(c) fitting into the channel formed by ridges 102 to cover an end of the combined containers 10(a) and 10(b), thereby serving to hold them together, the ridge 102 and cut lip 16(c) serving to hold the container 15(c) in place.

Referring now to FIGS. 22 and 23, the ability to produce a cut lip 16 facing inward toward the volume of the thermoformed container permits a dead hinge construction (i.e., a hinge without a flexure of the thermoplastic material) to be used. Here, a ridge 20 of container 10(a) is formed into a relatively large cylindrical form having hemicircular cross-section and conforming to an expanded ridge 60 on container 10(b). The cylindrical form may be bisected by a circular disk 104, integrally molded with ridge 20 and shown in dotted lines in FIG. 22. Ridge 20 including disk 104 and ridge 60 extend about the axis of their cylinders for greater than 180.degree. to provide a hinging action where they retain their connection as the remaining portions of containers 10(a) and 10(b) are separated in rotation about the cylinder axis. The remaining opposite side of containers 10(a) and 10(b) form the hinge 104 of container 103 and may include the release mechanism described with respect to FIG. 14.

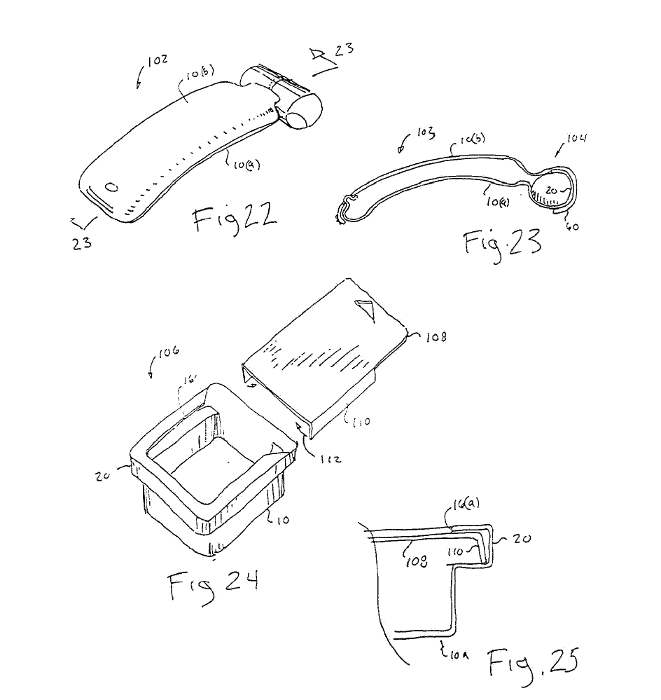

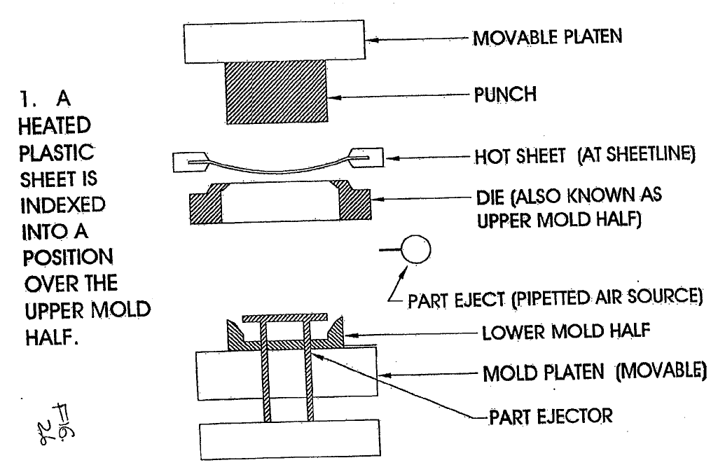

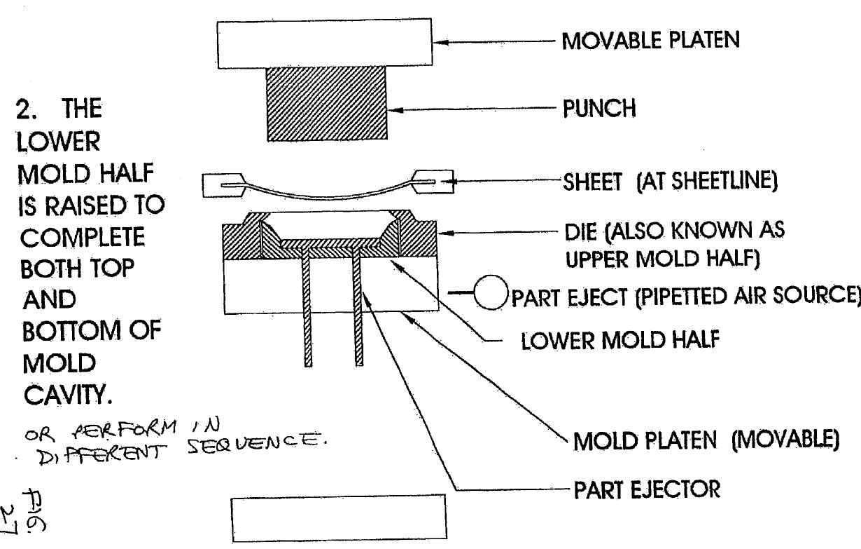

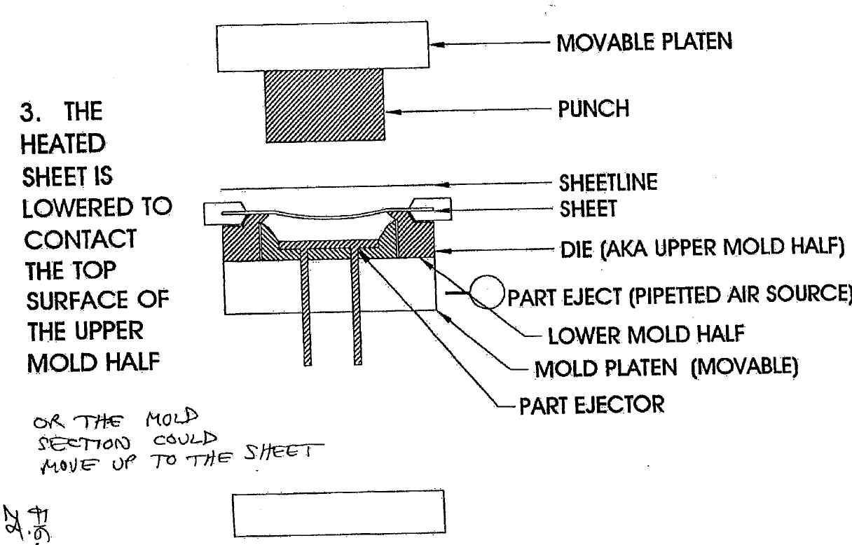

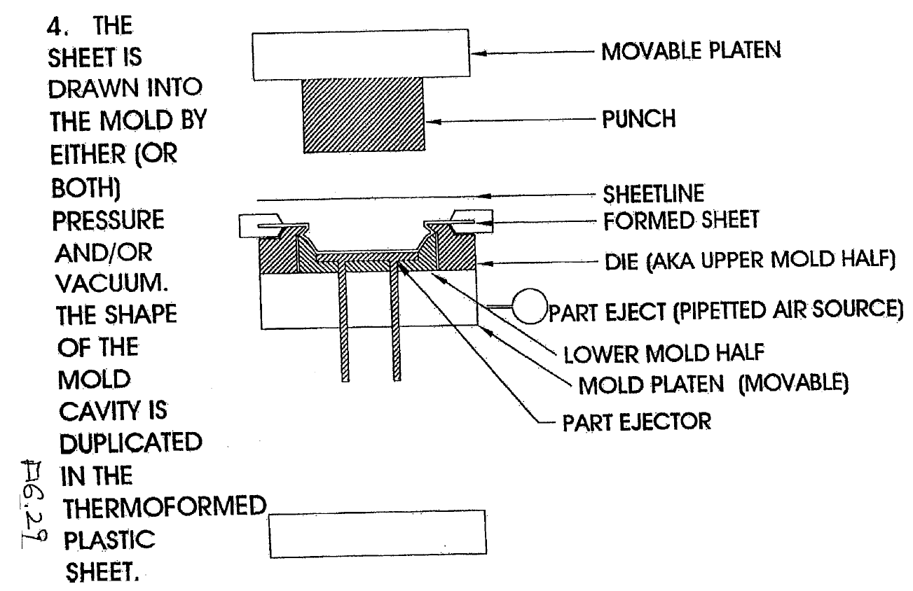

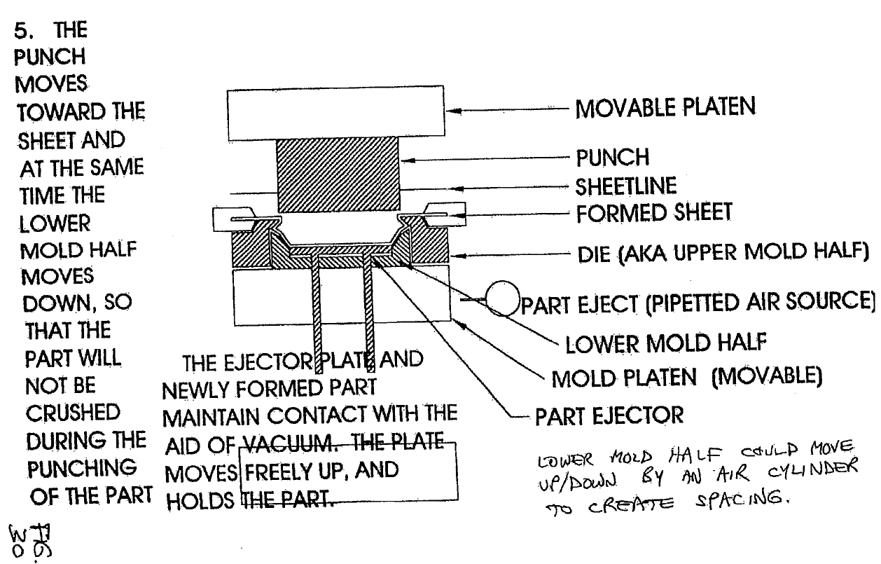

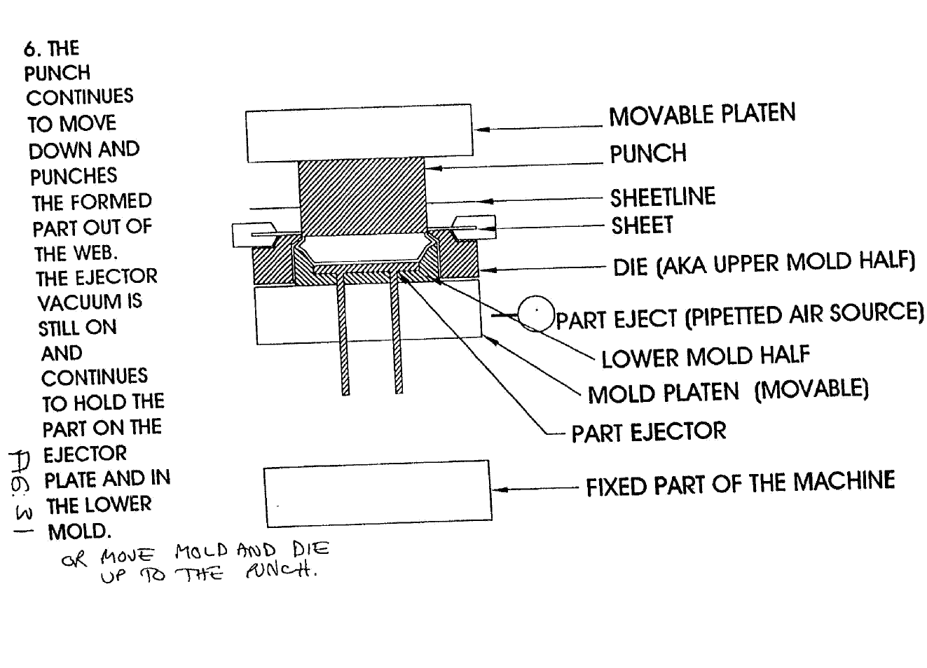

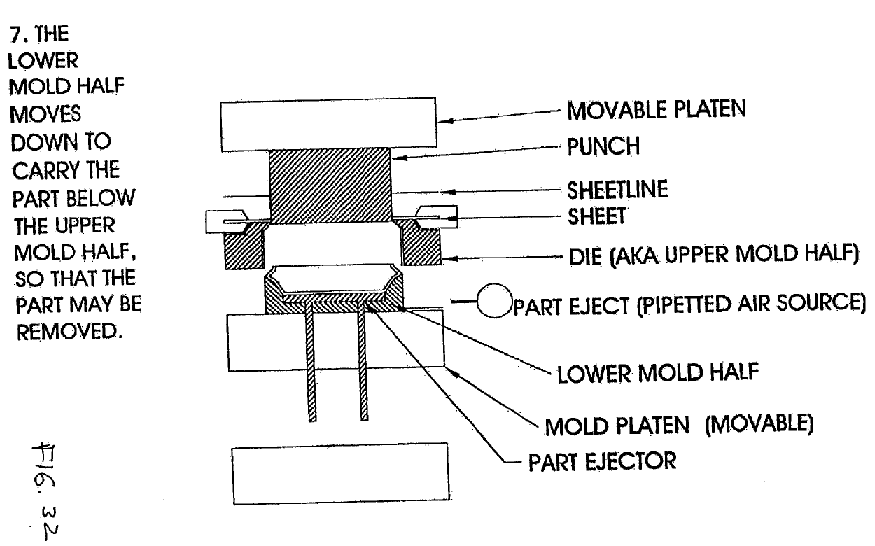

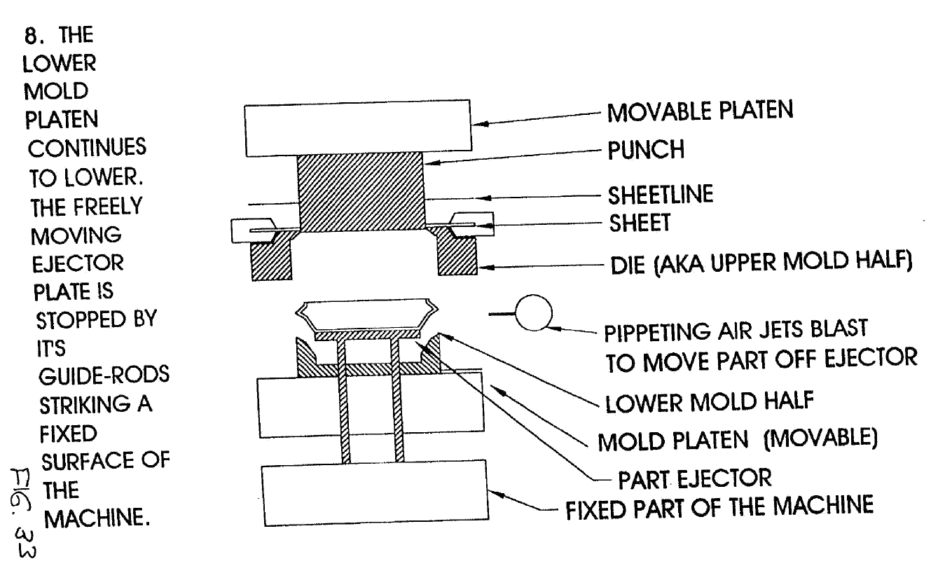

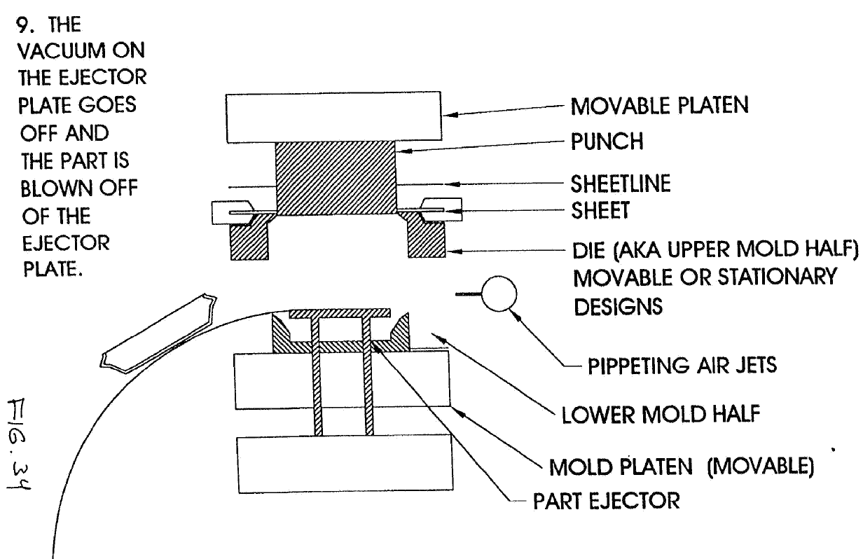

Referring now to FIGS. 24 and 25, a container 106 may be formed from a box shaped container 10 having a rectangular ridge 20 as was described with respect to FIG. 7 where the inwardly extending cut lip 16(a) extends only along three sides of the upper edge of the container 10. A paperboard or card stock backer plate 108 may be inserted beneath the radially inward extending cut lip 16, thereby being retained as a cover to container 10. The cardboard backer plate 108 may have downwardly extending ears 110 attached at opposite edges that will slide beneath cut lip 16. The ears may be folded upward as indicated by arrows 112 against the backer plate 108 so that the backer plate 108 may slide over the container 10 and beneath the radial upper edge leading to the cut lip 16 and then fold downward into the recess formed by ridge 20, thus preventing the backer plate 108 from sliding out again without significant effort.

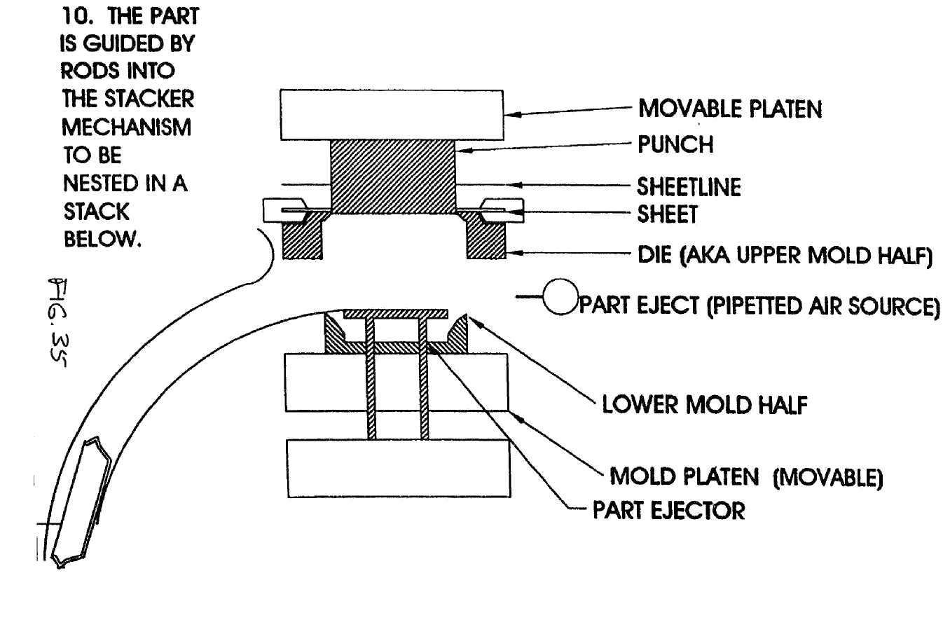

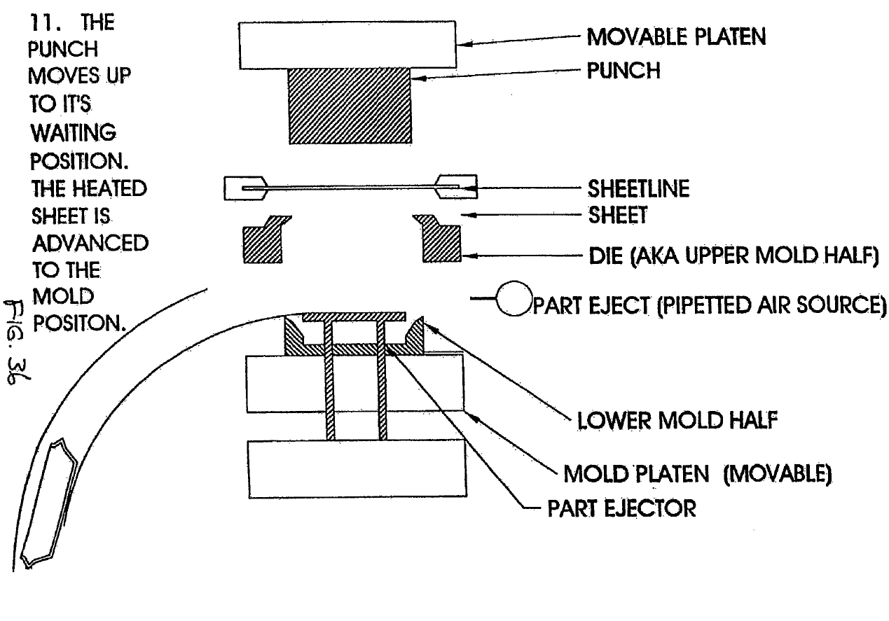

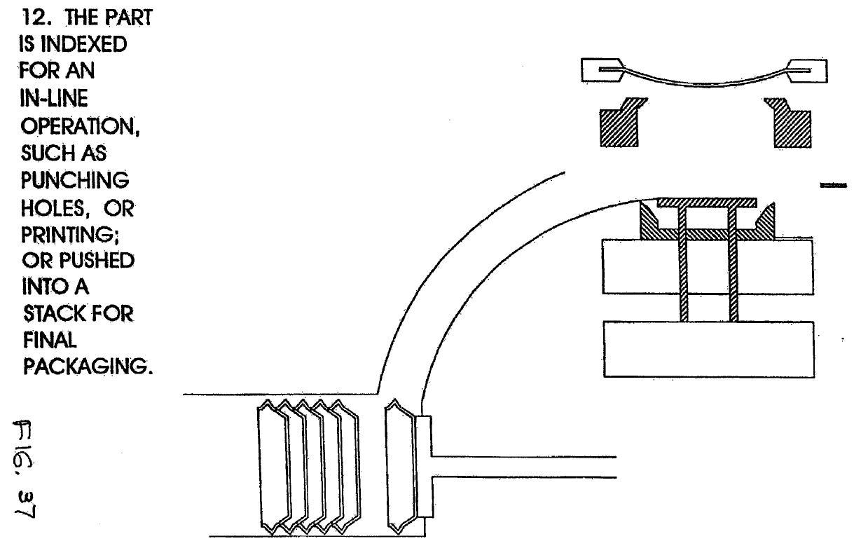

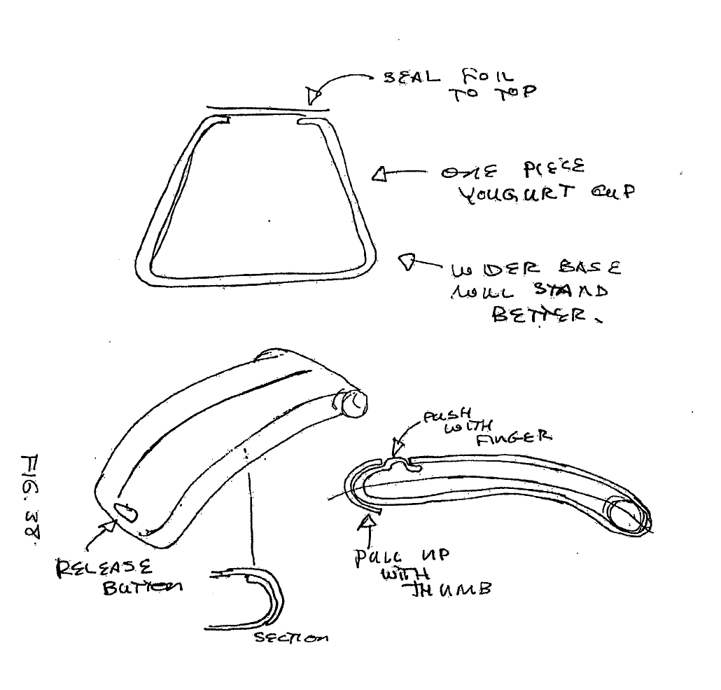

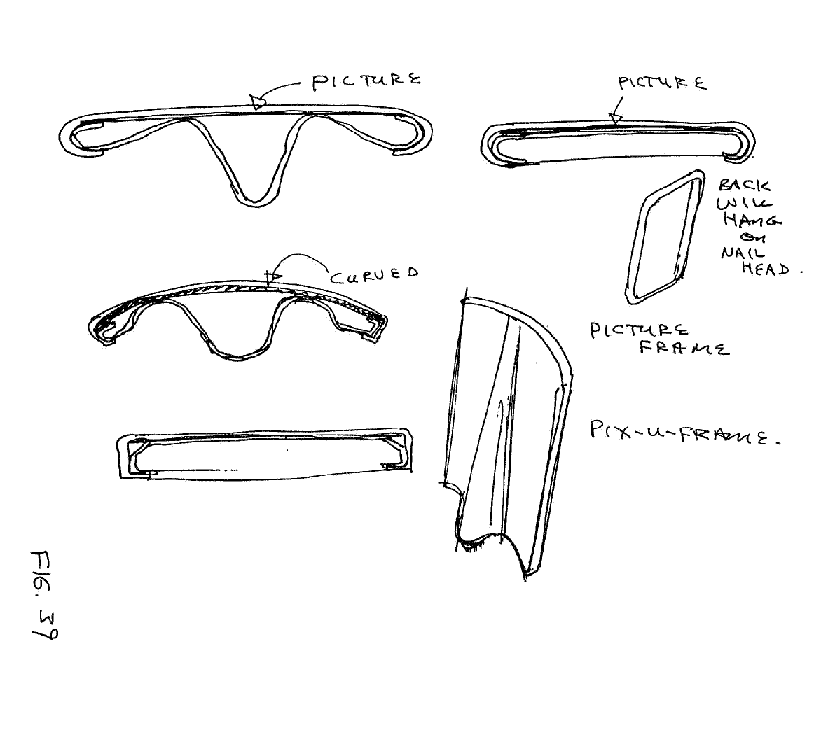

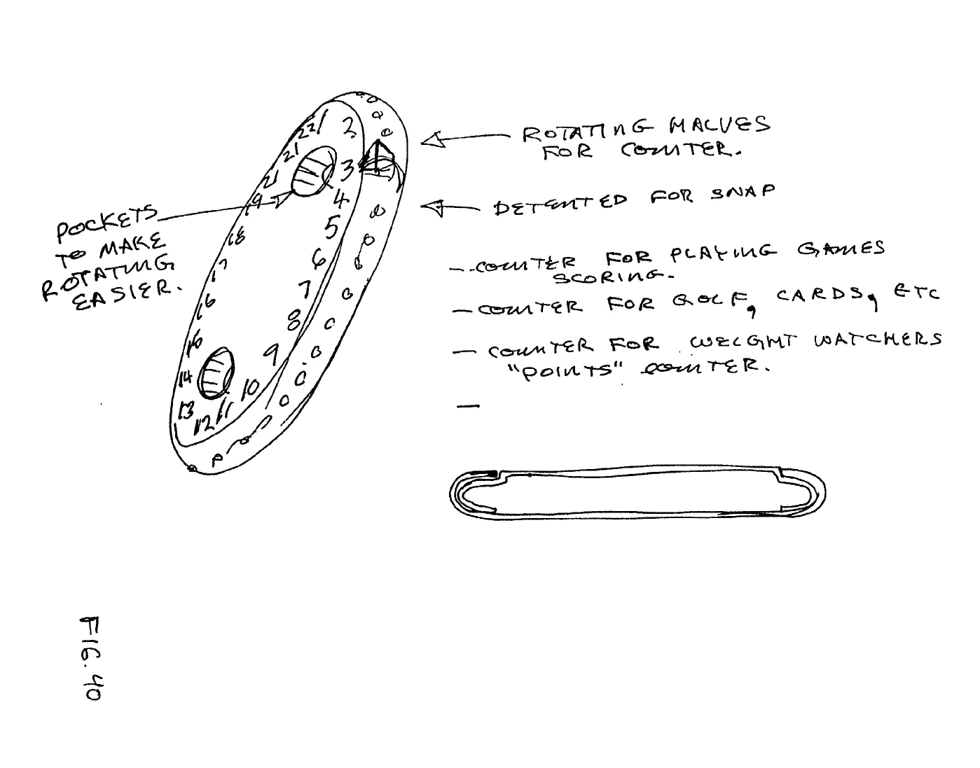

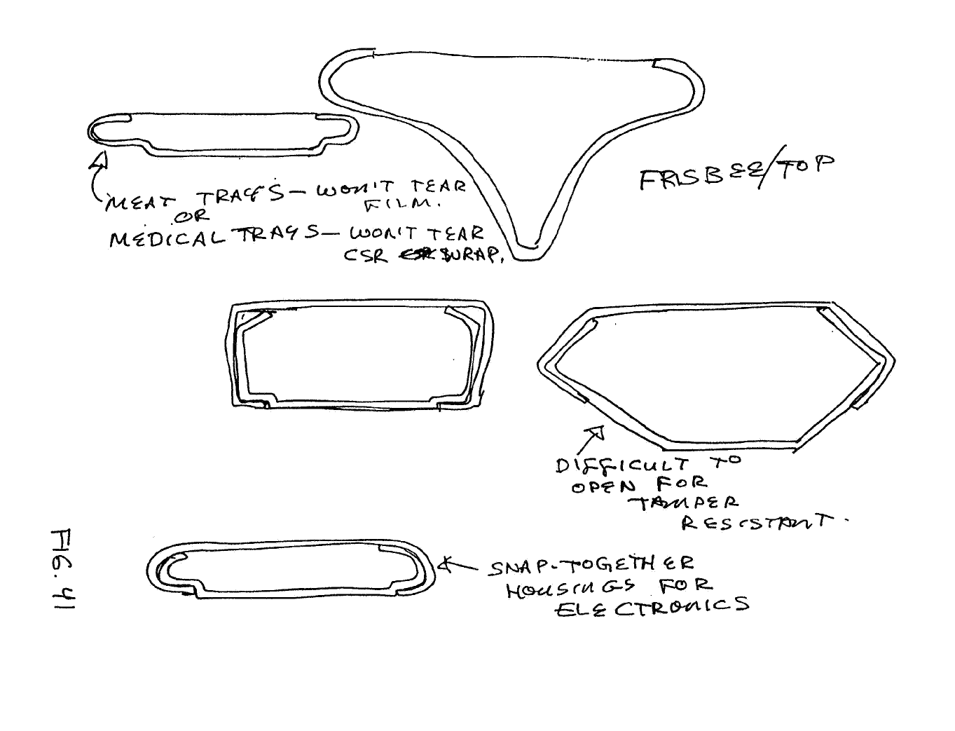

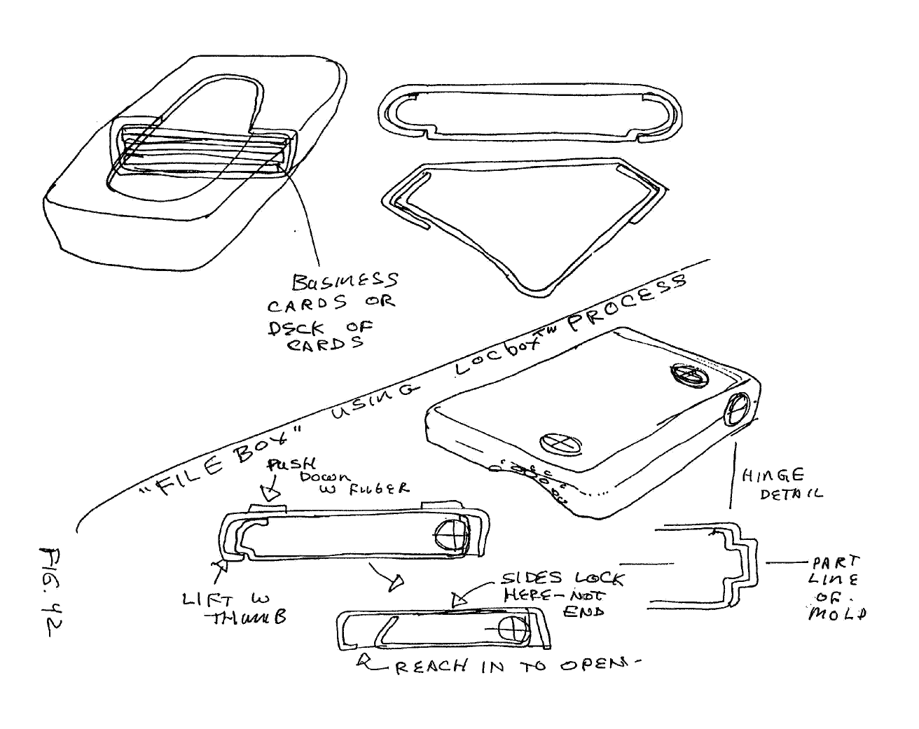

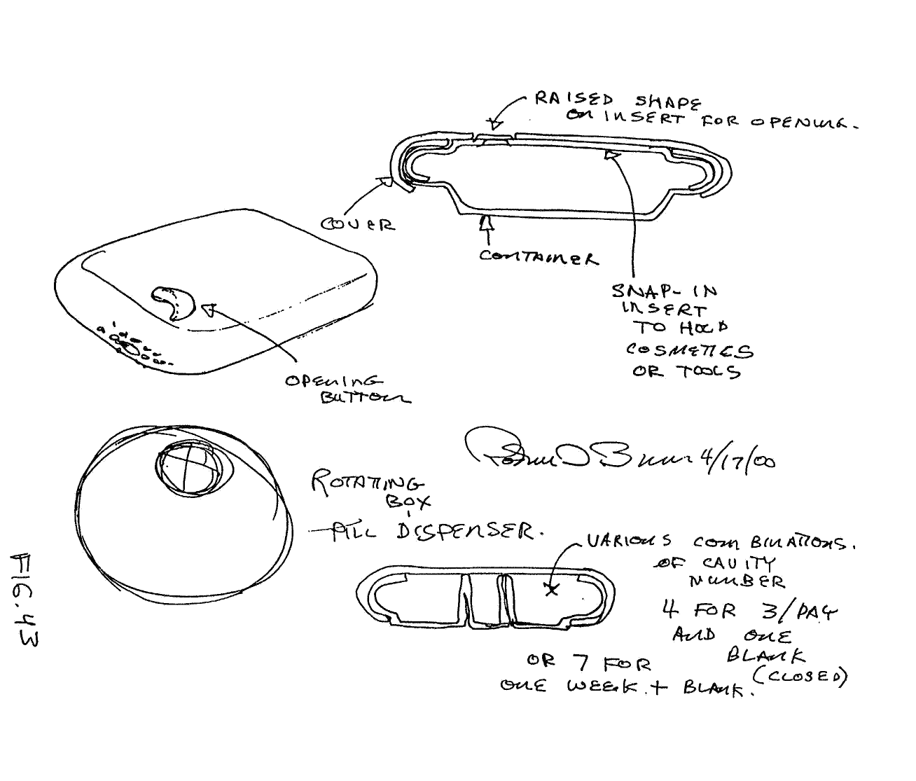

Referring now to FIGS. 26, 27, 28, 29, 30, 31, 32, 33, 34, 35, 36, and 37, is schematically illustrated one technique of forming the thermoformed container 10. As should be appreciated, the technique illustrated in these figures has been described previously in the application. As illustrated in FIGS. 26 and 27, a heated thermoplastic sheet is positioned over the upper mold half or first portion, the lower mold half or second portion, and the ejector or third portion. The technique of forming the container 10 is not relevant to the sequence of moving either the upper mold half, the lower mold half, or the ejector in FIGS. 26 and 27. Next, the heated thermoplastic material contacts the top surface of the upper mold half as shown in FIG. 28. The technique of forming the container 10 is not relevant to the sequence of moving either the three-part mold or the thermoplastic sheet in FIG. 28. As illustrated in FIG. 29, the thermoplastic sheet is forced into the cavity of the three-part mold and the shape of the cavity is transferred to the thermoplastic sheet. The thermoplastic sheet is forced into the cavity by pressure applied to the interior of the container, a vacuum, or a combination thereof. As shown in FIG. 30, the punch moves toward the thermoplastic sheet while the lower mold half moves slightly away from the thermoplastic sheet. Beneficially, the combined downward movement of the punch and the lower mold half avoids crushing the thermoplastic sheet during the punching or cutting of the sheet. The ejector and the thermoplastic sheet maintain contact with the assistance of a vacuum while the ejector moves up. The technique of forming the container 10 is not relevant to the sequence of moving the punch, the lower mold half, or the ejector in FIG. 30. As illustrated in FIG. 31, the punch continues to move down and punches or cuts the thermoplastic material to form the container while the vacuum continues to hold the container on the ejector and in the lower mold. Conversely, the upper mold and the lower mold can move towards the punch. As shown in FIG. 32, the lower mold half and the ejector moves away from the upper mold half in a downward direction. As shown in FIG. 33, the lower mold half continues to move down; however, the ejector is stopped by striking a fixed surface. As shown in FIG. 34, the lower mold half is below the container as the vacuum is turned off and the container is blown off the ejector via air jets. As shown in FIGS. 35, 36, and 37, the container is guided into a stacking mechanism to nest a plurality of containers while a new thermoplastic sheet is positioned under the adjusted punch and over the three-part mold.

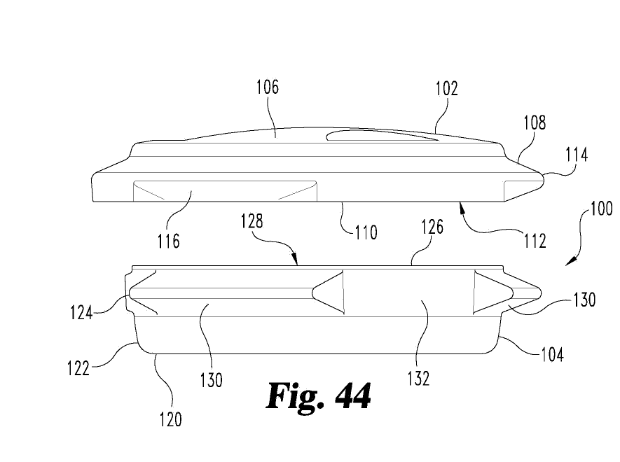

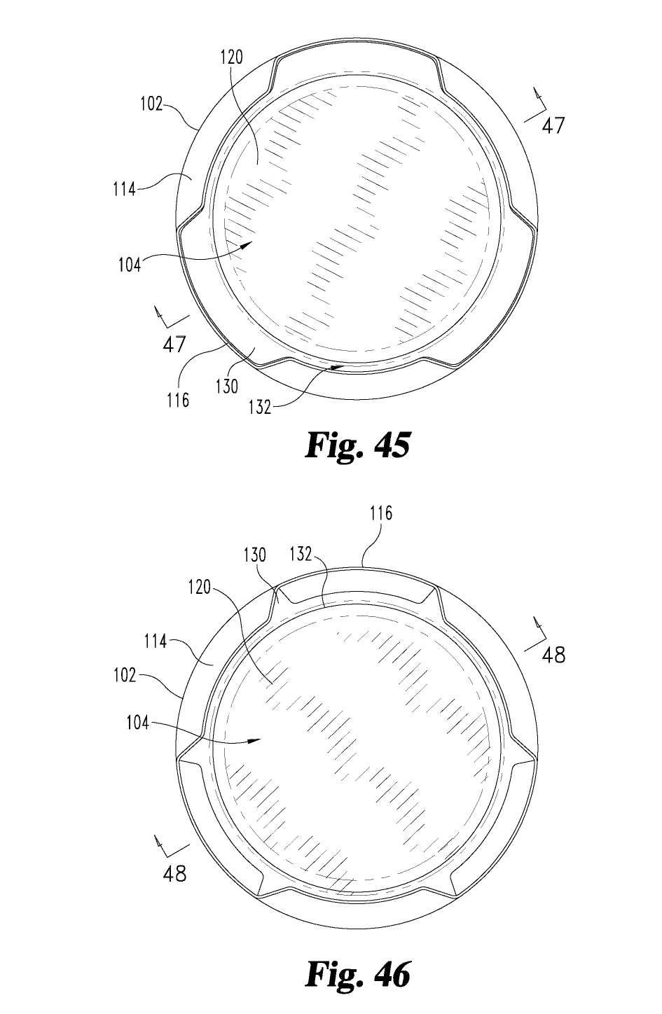

One embodiment of a thermoformed container 100 is shown in FIGS. 44, 45, and 46. The thermoformed container 100 includes an upper container 102 connectable to a lower container 104 to form a sealable, self-locking receptacle. The upper container 102 is sized to receive the lower container 104 wherein the upper container 102 and the lower container 104 fit together to seal contents within a cavity 105. The upper container 102 and the lower container 104 each have a circular shape. The circular shape of containers 102 and 104 enable the containers 102 and 104 to rotate about each other to lock together and with additional rotation the containers 102 and 104 unlock. As shown in FIG. 45, the containers 102 and 104 have an unlocked position wherein the containers 102 and 104 are mated together; however, the containers 102 and 104 are not locked. In this unlocked position, the containers 102 and 104 are separable by pulling them apart to expose the interiors of containers 102 and 104. The containers 102 and 104 also have a locked position wherein the containers 102 and 104 are mated together and locked as shown in FIG. 46. In this locked position, the containers 102 and 104 can not be separated by pulling them apart; instead the containers 102 and 104 are separated by twisting or rotating the container 102 about the container 104 or vice versa to the unlocked position and pulling containers 102 and 104 apart. The upper container 102 and the lower container 104 can each be formed in a thermoforming machine 22, as previously described; however, the cavity 24 of the thermoforming machine 22 is configured to correspond to the shape of either upper container 102 or lower container 104.

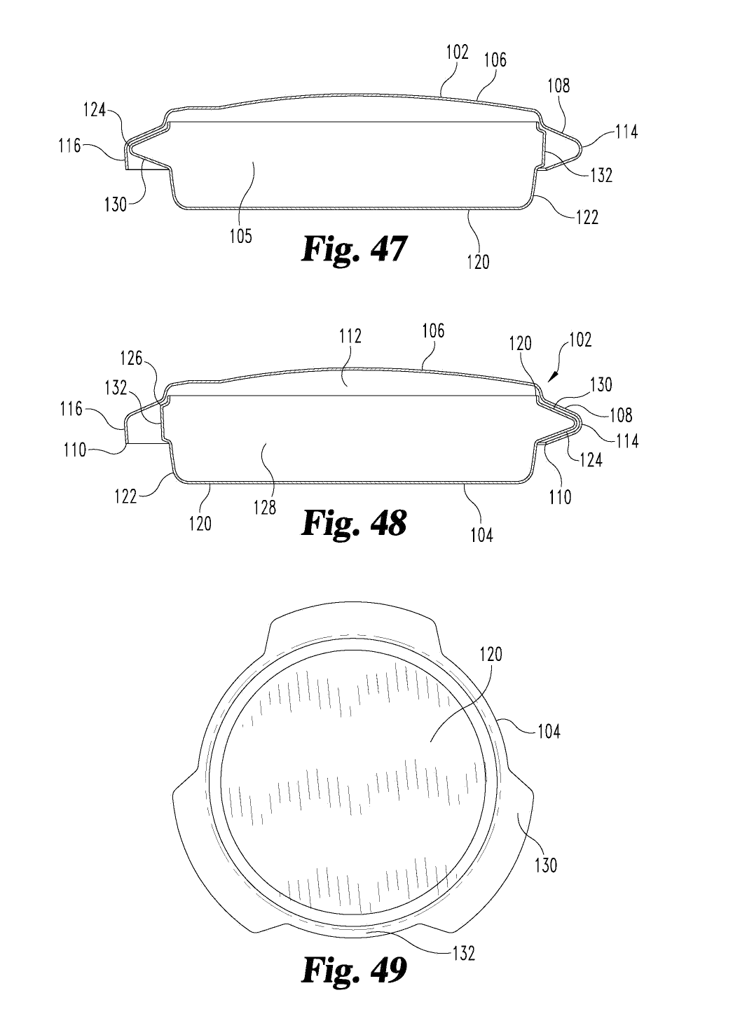

One embodiment of the upper container 102 is illustrated in FIGS. 44, 47 and 48. The upper container 102 includes an upper portion 106 that forms a lid or top and the upper portion 106 extends to a ridge 108. The ridge 108 surrounds the upper portion 106, therefore the upper portion 106 and the ridge 108 will have similar shapes. As illustrated, the upper portion 106 and the ridge 108 are circular in shape. The ridge 108 extends to a cut lip 110. The upper portion 106, the ridge 108, and the cut lip 110 define a volume 112 of the upper container 102. As illustrated, the ridge 108 includes three inwardly projecting portions 114 that alternate with three vertically extending sidewall portions 116. The inwardly projecting portions 114 form an acute angle with the ridge 108. In other embodiments, any number of inwardly projecting portions 114 and sidewall portions 116 can be included in the ridge 108. As should be appreciated, the thermoforming machine 22 and the cavity 24 are configured to form a varied shape for the ridge 108 that results in a combination of inwardly projecting portions 114 and vertically extending sidewall portions 116. Moreover, the machine 22 and the cavity 24 can be configured differently to manufacture different shapes for the projecting portions 114 and sidewall portions 116. As described in more detail below, the ridge 108 is similarly shaped to a ridge of the lower container 104 to assist in snapping and locking the upper container 102 and lower container 104 together. Further, to connect the upper container 102 to the lower container 104 the ridge 108 is slightly deformed as the containers 102 and 104 are joined together to permit the ridge 108 to fit over or snap on the ridge of the lower container 104. In other embodiments, the ridge 108 does not deform as the containers 102 and 104 are joined together.

One embodiment of the lower container 104 is illustrated in FIGS. 44, 47, 48 and 49. The lower container 104 includes a base 120 that forms a bottom and the base 120 extends to a lower sidewall 122. The lower sidewall 122 surrounds the base 120 and extends from the base 120 to a ridge 124. The lower sidewall 122 is substantially vertical with respect to the base 122; however, in other embodiments the lower sidewall 122 may form an obtuse angle with the base 120. In this embodiment, the base 120 is circular therefore the shape of the lower sidewall 122 is also circular. In other embodiments the base 120 and the lower sidewall 122 may form a different shape such as rectangular, square, or oval. The ridge 124 extends to a cut lip 126. The base 120, lower sidewall 122, ridge 124, and the cut lip 126 define a volume 128 of the lower container 104. As illustrated, the ridge 124 includes three inwardly projecting portions 130 that alternate with three sidewall portions 132. The inwardly projecting portions 130 form an acute angle with the ridge 124. In other embodiments, any number of inwardly projecting portions 130 and sidewall portions 132 can be included in the ridge 124. However, the same number of projecting portions 114 and 130 are required to form a tight seal when the containers 102 and 104 are assembled. Similarly, the same number of sidewall portions 116 and 132 are required to form a tight seal when the containers 102 and 104 are assembled. The ridge 124 is sized to fit in the ridge 108 of the upper container 102 as described in more detail below.

To assemble the upper container 102 to the lower container 104, the ridge 124 is inserted into the ridge 108. In particular, the inwardly projecting portions 130 of the lower container 104 are aligned with the sidewall portions 116 of the upper container 102. Similarly, the sidewall portions 132 of the lower container 104 are aligned with the inwardly projecting portions 114 of the upper container 102. The inwardly projecting portions 114 and 130 of the containers 102 and 104 deform slightly as the inwardly projecting portions 114 and 130 slide over the cut lips 126 and 110, respectively, as the ridge 124 is inserted into the ridge 108. Moreover, the sidewall portions 116 and 132 of the containers 102 and 104 may also deform slightly as the sidewall portions 116 and 132 slide over the cut lips 126 and 110, respectively, as the ridge 124 is inserted into the ridge 108. In other embodiments, the inwardly projecting portions 114 and 130, the sidewall portions 116 and 132, and the cut lips 110 and 126 do not deform as the containers 102 and 014 are assembled. In the unlocked position, the inwardly projecting portions 114 and 130 are adjacent the sidewall portions 132 and 116, respectively. To lock the upper container 102 with the lower container 104, the containers 102 and 104 are rotated about each other until the inwardly projecting portions 114 and 130 align with the sidewall portions 132 and 116, respectively. In one embodiment, in either the open or closed position, the cut lip 126 of the lower container 104 presses against the upper portion 106 of the upper container 102. To unlock the upper container 102 from the lower container 104, the containers 102 and 104 are rotated about each other until the inwardly projecting portions 114 align with the sidewall portions 132 and the sidewall portions 116 align with the inwardly projecting portions 130. To separate the upper container 102 from the lower container 104, the containers 102 and 104 are placed in the unlocked position and the container 102 is pulled off or separated from the container 104. As the containers 102 and 104 are separated from each other, the inwardly projecting portions 114 and 130 slide over the sidewall portions 132 and 116, respectively.

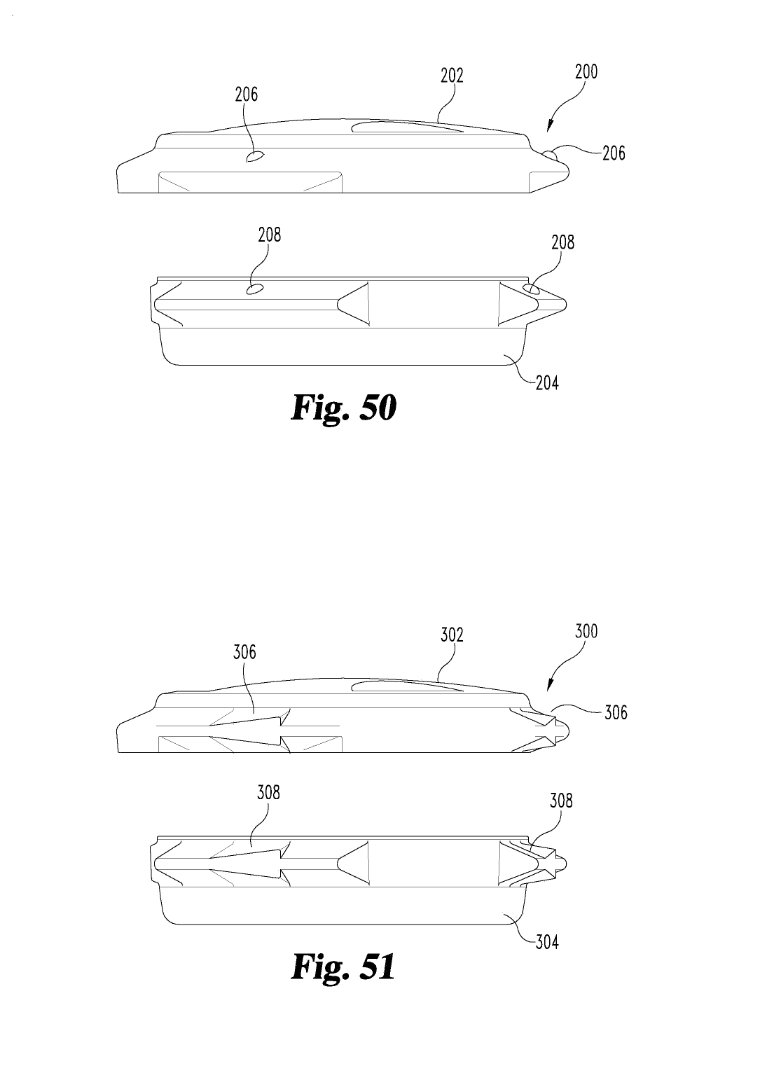

Another embodiment of a thermoformed container 200 is shown in FIG. 50. The container 200 is similar to the container 100. Therefore, for the sake of brevity the common elements between containers 200 and 100 will not be described again. The container 200 includes an upper container 202 similar to the upper container 102. However, the upper container 202 defines a plurality of notches or pockets 206 on the ridge. The container 200 also includes a lower container 204 similar to the lower container 104. However, the lower container 204 includes a plurality of protrusions 208 on the ridge. The protrusions 208 are sized and positioned to nest with the notches 206 when the containers 202 and 204 are in a locked position. As illustrated, the notches 206 and the protrusions 208 are circular in shape. In other embodiments, the notches 206 and the protrusions 208 have different shapes but the notches 206 and the protrusions 208 are similarly sized and shaped to each other to nest together. For example, the notches 206 and the protrusions 208 may be oval, square, or rectangular in shape. To lock the containers 202 and 204 together, the ridge of the container 204 is inserted into the ridge of the container 202 and the containers are rotated about each other until the inwardly projecting portions align with the sidewall portions and the protrusions 208 nest with the pockets 206. To unlock the containers 202 and 204, the containers are rotated about each other such that the protrusions 208 de-nest from the notches 206 and the inwardly projecting portions of the container 202 align with the sidewall portions of the container 204. Moreover, in the unlocked position, the sidewall portions of the container 202 align with the inwardly projecting portions of the container 204.

Another embodiment of a thermoformed container 300 is shown in FIG. 51. The container 300 is similar to the container 100. Therefore, for the sake of brevity the common elements between containers 300 and 100 will not be described again. The container 300 includes an upper container 302 similar to the upper container 102. However, the upper container 302 defines a notch 306 on the ridge. The container 300 also includes a lower container 304 similar to the lower container 104. However, the lower container 304 includes a ramp 308 on the ridge. The notch 306 and the ramp 308 are similarly sized and shaped to each other to nest together. As illustrated, the notch 306 and the ramp 308 are triangular in shape. As should be appreciated, the triangular shape of the notch 306 and the ramp 308 provides a gradual locking mechanism such that as the containers 302 and 304 are rotated about each other the ramp 308 enters the notch 306 and continues to slide into the notch 306 until the ramp 308 reaches the end of the notch 306 which results in a tactile sensation for the user. The tactile sensation for the user ensures that the containers 302 and 304 are locked together. To lock the containers 302 and 304 together, the ridge of the container 304 is inserted into the ridge of the container 302 and the containers are rotated about each other until the inwardly projecting portions align with the sidewall portions and the ramp 308 enters the notch 306. To unlock the containers 302 and 304, the containers 302 and 304 are rotated in an opposite direction and the ramp 308 exits the notch 306. In the unlocked position, the inwardly projecting portions of the container 302 align with the sidewall portions of the container 304. Moreover, in the unlocked position, the sidewall portions of the container 302 align with the inwardly projecting portions of the container 304.

The above description has been that of a preferred embodiment of the present invention. It will occur to those that practice the art that many modifications may be made without departing from the spirit and scope of the invention. In order to apprise the public of the various embodiments that may fall within the scope of the invention, the following claims are made.

What is claimed is:

1. A method of thermoforming a container, comprising:
positioning a heated sheet of thermoplastic material over a three-part mold defining a cavity corresponding to the shape of the container, wherein the mold includes separable first, second, and third portions, the first portion including an upper lip and an upper part of an undercut portion, wherein the undercut portion forms a ridge in the container, the second portion including a lower part of the undercut portion and a surface corresponding to sidewalls of the container, and the third portion including a surface corresponding to a base of the container;
forcing the heated sheet of thermoplastic material into the cavity;
cooling the heated sheet of thermoplastic material below its corresponding glass transition temperature;
cutting the cooled sheet of thermoplastic material along the upper lip of the mold to form the container;
separating the first portion from the container positioned in the second and third portions of the mold by moving either the first portion or the second and third portions away from each other;
moving the second portion away from the container and the third portion until the second portion is clear of the container; and
removing the container from the third portion of the mold.

2. The method of claim 1, wherein the forcing includes applying pressure to the inner surface of the base.

3. The method of claim 1, wherein the forcing includes vacuuming the base of the container.

4. The method of claim 1, wherein the forcing includes maintaining the force on the thermoplastic material until the container is removed from the third portion of the mold.

5. The method of claim 1, further comprising:
forming a plurality of containers; and
nesting the plurality of containers, wherein the lower part of the undercut portion of the first container rests against the upper lip of the second container.

6. A closable thermoformed container, comprising:
an upper container made of a thermoplastic material, the thermoplastic material positioned in a three-part mold defining a cavity corresponding to the shape of the upper container, the upper container having a top portion connected to a ridge, wherein the ridge includes a plurality of inwardly-projecting portions alternating with a plurality of sidewall portions, the inwardly-projecting portions and the sidewall portions extend to a cut lip to define the volume of the upper container;
a lower container made of a thermoplastic material, the thermoplastic material positioned in a three-part mold defining a cavity corresponding to the shape of the lower container, the lower container having a base connected with a continuous lower sidewall and a ridge, wherein the ridge includes a plurality of inwardly-projecting portions alternating with a plurality of sidewall portions, the inwardly-projecting portions and the sidewall portions extend to a cut lip to define a volume of the lower container; and
wherein the inwardly-projecting portions of the upper container and the lower container nest together and the sidewall portions of the upper container and the lower container align when the upper and lower containers are locked together.

7. The container of claim 6, wherein the sidewall portions of the upper container and the inwardly-projecting portions of the lower container align and the inwardly-projecting portions of the upper container and the sidewall portions of the lower container align when the upper and lower containers are joined together.

8. The container of claim 6, further comprising:
a locking device to permit rotational movement of the upper container about the lower container in one direction.

9. The container of claim 8, further comprising:
a third container positioned in the lower container and configured to be indexed by the locking device.

10. The method of thermoforming a container, comprising:
positioning a heated sheet of thermoplastic material over a three-part mold defining a cavity corresponding to the shape of the container, wherein the mold includes separable first, second, and third portions;
pressing the heated sheet of thermoplastic material into the cavity;
cutting the sheet of thermoplastic material along a lip of the first portion to form the container;
moving the container, the second portion, and the third portion downwardly away from the first portion;
contacting the third portion with an ejector plug to stop movement of the third portion while the second portion continues moving downwardly until clear of the container; and
removing the container from the third portion.

11. The method of claim 10, further comprising:
allowing the heated sheet of thermoplastic material to cool below its glass transition temperature.

12. The method of claim 10, wherein the pressing includes drawing the heated sheet of thermoplastic material.

13. The method of claim 10, wherein the removing includes applying pressure to the container until the container is removed from the third portion.

14. The method of claim 10, further comprising:
forming a plurality of containers; and
stacking the plurality of containers to define a gap between each pair of containers, the gap sized to receive a de-nesting pawl.
